(19) United States
(12) Patent Application Publication
(10) Pub. No.: US 2026/0115955 A1
(43) Pub. Date: Apr. 30, 2026

(54) Pipe Cutter with Handle Lock

(71) Applicant: Milwaukee Electric Tool Corporation, Brookfield, WI (US)

(72) Inventors: Jeffrey M. Flynn, Milwaukee, WI (US); Scott M. Hangartner, Richfield, WI (US); Ashton D. Speier, Milwaukee, WI (US)

(21) Appl. No.: 19/330,087

(22) Filed: Sep. 16, 2025

Related U.S. Application Data
(60) Provisional application No. 63/712,888, filed on Oct. 28, 2024.

(51) Int. Cl. B26D 3/16

(52) U.S. Cl. CPC B26D 3/169

(57) ABSTRACT

A tool for cutting a pipe is provided. The tool includes a body with an upper handle, a lower handle pivotally coupled to the body, and a blade located at a first end of the body. The lower handle includes an arm. A locking lever is coupled to the body and is configured to move between a locked position and an unlocked position. A shaft is coupled to the lever and includes a protrusion that extends radially away from the shaft. When the lever is in the locked position, the protrusion of the shaft engages with the arm of the lower handle to limit movement of the lower handle with respect to the body.

### CROSS-REFERENCE TO RELATED PATENT APPLICATION

The present application claims the benefit of and priority to U.S. Provisional Application No. 63/712,888 filed on Oct. 28, 2024, which is incorporated herein by reference in its entirety.

### BACKGROUND OF THE INVENTION

The present invention relates generally to the field of tools. The present invention relates specifically to a cutting tool, such as a pipe cutter, including structure for ratcheting a blade and a handle locking mechanism.

### SUMMARY OF THE INVENTION

One embodiment of the invention relates to a cutting tool. The cutting tool has a body with a first end defining an opening, a second end opposing the first end, a cavity, and a first handle. The cavity is positioned in the body and connected to the opening. The first handle extends between the opening and the second end. A second handle is pivotally coupled to the body. The second handle includes a pivot end positioned within the cavity and an arm extending from the pivot end. The cutting tool further includes a blade and a locking mechanism. The blade is pivotally coupled to the body and positioned at least partially within the cavity. The locking mechanism includes a shaft rotatably coupled to the body and positioned within the cavity and a locking lever. The locking lever is coupled to the body and to the shaft and moveable between an unlocked position and a locked position in which the shaft engages the arm of the second handle to resist movement of the second handle with respect to the body.

Another embodiment of the invention relates to a cutting tool. The cutting tool has a body with a first end defining an opening, a second end opposing the first end, a cavity, and a first handle. The cavity is positioned in the body and connected to the opening. The first handle extends between the opening and the second end. A second handle is pivotally coupled to the body. The second handle includes a pivot end positioned within the cavity and an arm extending from the pivot end. The cutting tool further includes a blade and a locking mechanism. The blade is pivotally coupled to the body and moveable with respect to the opening. The locking mechanism is coupled to the body and includes a shaft, a protrusion, and a lever. The shaft is rotatably coupled to the body and positioned within the cavity. The shaft is rotatable about a locking axis. The protrusion extends radially outward from the shaft. The lever includes a first end coupled to the body and to the shaft and a second, actuator end opposing the first end of the lever.

Another embodiment of the invention relates to a cutting tool. The cutting tool has a body with a first end defining an opening, a second end opposing the first end, a cavity, and a first handle. The cavity is positioned in the body and connected to the opening. The first handle extends between the opening and the second end. A second handle is pivotally coupled to the body. The second handle includes a pivot end positioned within the cavity and an arm extending from the pivot end. The cutting tool further includes a blade and a locking mechanism. The locking mechanism includes a shaft rotatably coupled to the body and positioned within the cavity and a lever coupled to the body and to the shaft. The blade is pivotally coupled to the body. The blade includes an inner edge defining a cutting portion and an outer edge including a plurality of teeth. The cutting tool further includes a pawl coupled to the second handle. The pawl is configured to selectively engage with plurality of teeth of the blade.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a pipe cutter in a locked position, according to an exemplary embodiment.

FIG. 2 is a perspective view of the pipe cutter of FIG. 1 in the locked position, with a side of the body removed and a blade shown in phantom lines, according to an exemplary embodiment.

FIG. 3 is a perspective view of the pipe cutter of FIG. 1 in an unlocked position, with a side of the body removed and a blade shown in phantom lines, according to an exemplary embodiment.

FIG. 4 is a detailed view of the first end of the pipe cutter of FIG. 2, according to an exemplary embodiment.

FIG. 5 is a detailed view of protrusion of the locking lever, shaft, and protrusion of the pipe cutter of FIG. 4, according to an exemplary embodiment.

### DETAILED DESCRIPTION

Referring generally to the figures, various embodiments of a tool for cutting a pipe or tube (e.g., plastic pipes, polyvinyl chloride (PVC) pipes, rubber tubbing, etc.) are shown and described. Specifically, the tools discussed herein have a body with an upper handle, a lower handle pivotally coupled to the body, a blade, and a locking lever. The lower handle includes an arm. The locking lever is configured to move between a locked position and an unlocked position and is coupled to a shaft with a protrusion. The lever is positioned along the side of the body adjacent to where a user's thumb would be during use of the tool. When a user moves the lever into the locked position, the protrusion of the shaft engages with the arm of the lower handle to lock the lower handle in a closed position. As compared to typically pivoting style handle locks located at the ends of the handles on a typical pipe cutter, Applicant believes that this handle locking structure provides quicker and easier access to the locking lever during operation and may allow a user to lock the tool with one hand.

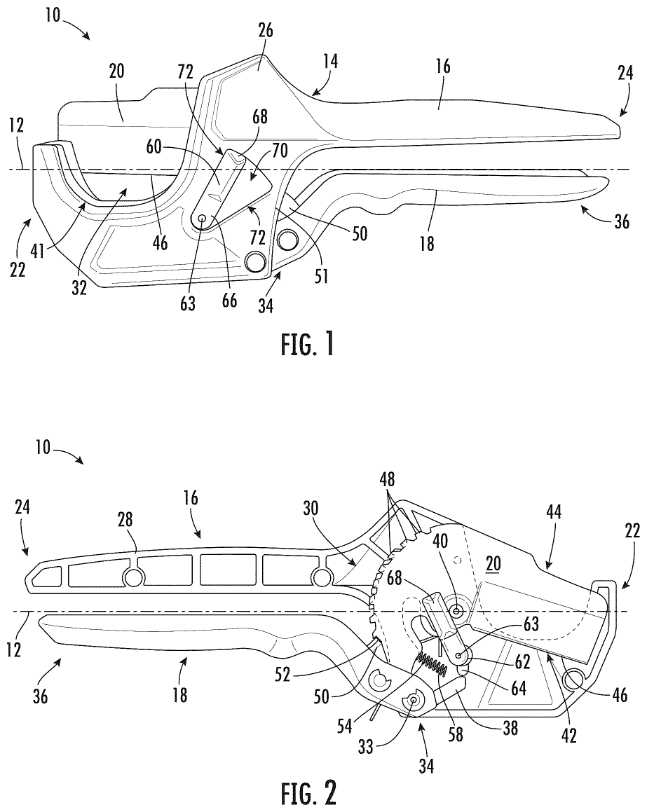

Referring to FIGS. 1-3, a tool, shown as pipe cutter 10, is shown and described. Pipe cutter 10 includes a body 14 with a first or upper handle 16, a second or lower handle 18, and a blade 20. Pipe cutter 10 is configured to cut a workpiece, such as a PVC pipe. When lower handle 18 is moved with respect to upper handle 16, blade 20 is incrementally moved between a first position (i.e., a position where blade 20 defines an opening with body 14 that is configured to receive a workpiece, in other words blade 20 is spaced from body 14) and a second position (i.e., a position where blade 20 is closed and abuts the body) such that blade 20 cuts the workpiece.

Body 14 extends along a longitudinal axis 12 and includes a first end 22 and a second end 24 opposite first end 22 along longitudinal axis 12. Body 14 includes a first side 26 and a second side 28 opposite first side 26. A cavity 30 is defined within body 14 between first side 26 and second side 28. An opening or throat 32 is defined at first end 22 of body 14. As shown, throat 32 is U-shaped and configured to receive a workpiece. Upper handle 16 extends between throat 32 and second end 24. Upper handle 16 is formed from a single, continuous, contiguous piece of material with body 14.

Lower handle 18 is pivotally coupled to body 14. Lower handle 18 includes a first end or pivot end 34 positioned within cavity 30 of body 14 and a second end 36 opposite pivot end 34. Lower handle 18 extends from within cavity 30 past a rearward facing edge 51 of body 14. Rearward facing edge 51 is positioned between throat 32 at first end 22 of body 14 and upper handle 16 and/or second end 24 of body 14. Rearward facing edge 51 of body 14 faces toward second end 36 of lower handle 18. Lower handle 18 includes a locking arm 38. Locking arm 38 extends away from pivot end 34 and is positioned withing cavity 30 between first side 26 and second side 28 of body 14. Lower handle 18 pivots with respect to body 14 about a pivot axis 33. Pivot axis 33 extends in a direction substantially perpendicular to longitudinal axis 12. In particular, lower handle 18 moves with respect to upper handle 16 between an open position and a closed position.

As shown in FIG. 2, lower handle 18 is in the closed position. Upper handle 16 and lower handle 18 are substantially parallel with each other. When moved from the open position to the closed position, locking arm 38 is moved in a direction away from blade 20 and away from upper arm 16.

As shown in FIG. 3, lower handle 18 is in the open position. When moved from the closed position to the open position, second end 36 is moved away from second end 24 of body 14 and locking arm 38 is moved towards blade 20 and upper arm 16.

Blade 20 is coupled to body 14 and is rotatable with respect to body 14 about a blade axis 40. Blade axis 40 is perpendicular to longitudinal axis 12. Specifically, blade 20 is pivotally mounted on body 14 and positioned within cavity 30 between first side 26 and second side 28. When blade 20 is coupled to body 14, at least a portion of blade 20 is located within throat 32. Blade 20 includes an inner edge 42 that faces towards a bottom 41 of throat 32 and an outer edge 44 opposite inner edge 42. A cutting portion 46 is defined along inner edge 42 and configured to cut a workpiece. A plurality of steps or teeth 48 are formed along a portion of outer edge 44. Teeth 48 are configured to engage with a ratcheting mechanism 50 used to rotate blade 20 with respect to body 14.

Ratcheting mechanism 50 is coupled to lower handle 18. Ratcheting mechanism 50 is configured to drive cutting portion 46 into engagement with body 14 to cut a workpiece, such as a pipe. Ratcheting mechanism 50 includes a pawl 52 having a tip configured to selectively engage each tooth in the plurality of teeth 48. In various embodiments, lever 60 is positioned between the opening 32 of the body and pawl 52. In various specific embodiments, lever 60 is positioned between the outer edge 44 of blade 20 and first end 22 of body 14.

When lower handle 18 is moved between the open position and closed position, ratcheting mechanism is configured to incrementally move blade 20 between a first position, where blade 20 defines an opening with body 14 that is configured to receive a workpiece, and a second position where cutting portion 46 interfaces with bottom 41 of throat 32. In other words, in the first position, blade 20 is spaced from body 14 and/or not engaged with body 14. As shown, when in the second position, cutting portion 46 extends past bottom 41 and is received within cavity 30 of body 14. The number of increments between the first position and the second position is determined by the number of the plurality of teeth 48. In the illustrated embodiment, there are ten teeth 48. In various embodiments, there may be a different number of teeth 48 (e.g., 8, 9, 11, 12, etc.)

A spring 54 is positioned within cavity 30. Spring 54 has a first end 56 and a second end 58 opposite first end 56. As shown in FIG. 3, when lower handle 18 is moved away from upper handle 16, a side of arm 38 interfaces against second end 58 to move blade 20 into the second position.

Pipe cutter 10 includes a locking lever, shown as lever 60 coupled to body 14. Locking lever 60 is configured to move between a locked position and an unlocked position. Locking lever 60 is coupled to a shaft 62. Shaft 62 is rotatably coupled to body 14 and positioned within cavity 30. A nub or protrusion 64 extends radially away or outward from shaft 62. When locking lever 60 is in the locked position, protrusion 64 engages with locking arm 38 of lower handle 18 to block and/or resist movement of lower handle 18 with respect to body 14. In this way, protrusion 64 limits the movement of lower handle 18 with respect to body 14 such that lower handle 18 is retained in the closed position. In various embodiments, locking arm 38 is positioned between tip 52 and first end 22 of body 14.

Lever 60 is located along or positioned on first side 26 of body 14. Lever 60 is located between throat 32 and upper handle 16 along longitudinal axis 12. In various embodiments, lever 60 is positioned along an exterior surface of the body 14 between the first end 22 of the body 14 and the lower handle 18. In various specific embodiments, lever 60 is positioned on first side 26 of body 14 between throat or opening 32 and rearward facing edge 51. This location is proximate to where a user's thumb is located when pipe cutter 10 is held by a user. In this way, Applicant believes that a user can more easily engage and disengage lever 60 when pipe cutter 10 is in use.

Lever 60 includes a first or fixed end 66 coupled to shaft 62 and a second or free end 68 opposite first end 66. In various embodiments, free end 68 is an actuator end configured to be engaged by a user (e.g., by a thumb, etc.). Shaft 62 is centered on and extends along a locking axis 63. Locking axis 63 extends in a direction substantially perpendicular to longitudinal axis 12 and substantially parallel with pivot axis 33 and blade axis 40. Free end 68 of lever 60 pivots with respect to locking axis 63 between the locked position and the unlocked position.

In various embodiments, body 14 includes an impression or recessed surface or section 70 on first side 26. In such embodiments, lever 60 is positioned on an exterior surface of body 14 and within recessed surface70. Recessed surface 70 is configured to resist or limit the movement of lever 60. When lever 60 is moved into the unlocked position or locked position, lever 60 abuts a wall 72 defined by recessed surface 70. In other words, in specific embodiments, recessed section 70 has a first wall 72 and a second wall 72 spaced from first wall 72. When lever 60 is in the locked position or the unlocked position, lever 60 abuts the first wall 72 or the second wall 72. In this way, lever 60 cannot be pivoted further than the locked position and unlocked position.

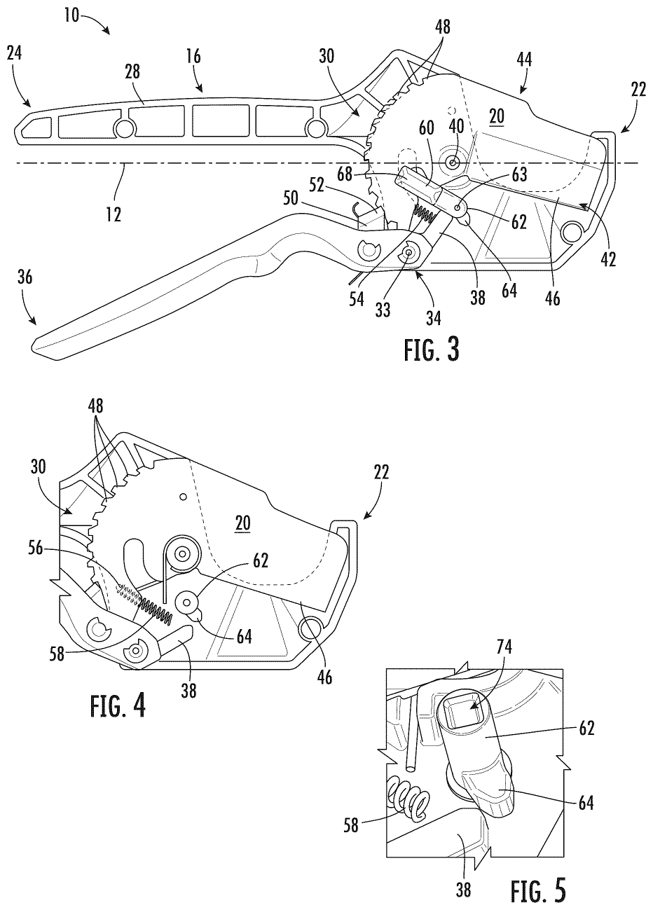

Shaft 62 is fixedly coupled to first end 66 of lever 60. When lever 60 is moved from the unlocked position to the locked position, shaft 62 rotates in a first direction (e.g., clockwise) around locking axis 63. When lever 60 is moved from the locked position to the unlocked position, shaft 62 rotates in a second direction opposite the first direction (e.g., counterclockwise) around locking axis 63. As shown in FIGS. 4-5, shaft 62 includes a bore 74 configured to receive and retain a peg or projection extending from first end 66 of lever 60. In various embodiments, bore 74 extends along the locking axis 63. In the illustrated embodiment, the bore 74 is a square-shaped bore. In various embodiments, bore 74 may have a different shape.

To move locking lever 60 to the unlocked position, a user moves free end 68 in a direction away from upper handle 16, away from blade 20, and towards lower handle 18. This may be accomplished by the user applying a downward force with their thumb to free end 68 (e.g., pushing free end 68 of lever 60 towards lower handle 18). As locking lever is moved from the locked position to the unlocked position, shaft 62 rotates in the first direction and protrusion 64 is rotated in the first direction away from pivot end 34 of lower handle 18.

Referring to FIG. 3, locking lever 60 is shown in the unlocked position and lower handle 18 is shown in the open position. When in the unlocked position, locking arm 38 can pivot freely within cavity 30. As shown, when in the open position, locking arm 38 extends below lever 60.

To move locking lever 60 to the locked position, a user moves free end 68 in a direction towards upper handle 16, towards blade 20, and away from lower handle 18. This may be accomplished by a user applying an upwards force with their thumb to free end 68 (e.g., pulling free end 68 of lever 60 towards upper handle 16). As locking lever is moved from the unlocked position to the locked position, shaft 62 rotates in the second direction and protrusion 64 is rotated in the second direction towards pivot end 34 of lower handle 18. When lower handle 18 is in the closed or locked position, protrusion 64 engages with locking arm 38 to limit movement of lower handle 18.

Referring to FIGS. 2, 4, and 5, locking lever 60, protrusion 64, and locking arm 38 are shown in the locked position. Lower handle 18 is shown in the closed position. As shown, locking arm 38 is engaged with an outer surface of protrusion 64 and limited from moving with respect to body 14 from the closed position to the open position.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A cutting tool comprising:
a body comprising:
a first end defining an opening;
a second end opposing the first end;
a cavity positioned in body and connected to the opening; and
a first handle extending between the opening and the second end;
a second handle pivotally coupled to the body, the second handle comprising:
a pivot end positioned within the cavity; and
an arm extending from the pivot end;
a blade pivotally coupled to the body, the blade positioned at least partially within the cavity; and
a locking mechanism comprising:
a shaft rotatably coupled to the body and positioned within the cavity; and
a locking lever coupled to the body and to the shaft, the locking lever moveable between an unlocked position and a locked position in which the shaft engages the arm of the second handle to resist movement of the second handle with respect to the body.

2. The cutting tool of claim 1, wherein the shaft further comprises a protrusion extending radially outward from the shaft, and wherein, when the locking lever is in the locked position, the protrusion engages the arm of the second handle.

3. The cutting tool of claim 1, wherein the locking lever is positioned along an exterior surface of the body between the first end of the body and the second handle.

4. The cutting tool of claim 1, wherein the locking lever comprises a fixed end coupled to the shaft and a free end opposing the fixed end.

5. The cutting tool of claim 4, wherein, when the free end of the locking lever is actuated, the locking lever moves toward the locked position or the unlocked position.

6. The cutting tool of claim 1, further comprising a recessed section positioned on an exterior surface of the body, wherein the locking lever is positioned within the recessed section.

7. The cutting tool of claim 6, wherein the recessed section comprises a first wall and a second wall, and wherein, when the locking lever is the locked position or the unlocked position, the locking lever abuts the first wall or the second wall.

8. The cutting tool of claim 1, wherein the blade comprises an inner edge defining a cutting portion and an outer edge, and wherein the outer edge comprises a plurality of teeth.

9. The cutting tool of claim 8, further comprising a ratcheting mechanism coupled to the second handle, the ratcheting mechanism comprising a pawl configured to selectively engage the plurality of teeth of the blade.

10. A cutting tool comprising:
a body comprising:
a first end defining an opening;
a second end opposing the first end;
a cavity positioned in body and connected to the opening; and
a first handle extending between the opening and the second end;
a second handle pivotally coupled to the body, the second handle comprising:
a pivot end positioned within the cavity; and
an arm extending from the pivot end;
a blade pivotally coupled to the body, the blade moveable with respect to the opening; and
a locking mechanism coupled to the body, the locking mechanism comprising:
a shaft rotatably coupled to the body and positioned within the cavity, the shaft rotatable about a locking axis; and
a protrusion extending radially outward from the shaft; and
a lever comprising:
a first end coupled to the body and to the shaft; and
a second, actuator end opposing the first end of the lever.

11. The cutting tool of claim 10, wherein the shaft further comprises a bore extending along the locking axis, and wherein the bore receives a projection extending from the first end of the lever.

12. The cutting tool of claim 10, wherein the protrusion engages the arm of the second handle to resist movement of the second handle relative to the body.

13. The cutting tool of claim 10, wherein the body further comprises a rearward facing edge positioned between the opening and the second handle.

14. The cutting tool of claim 13, wherein the lever is positioned on an exterior surface of the body between the opening and the rearward facing edge.

15. The cutting tool of claim 10, wherein the blade comprises an inner edge defining a cutting portion and an outer edge comprising a plurality of teeth, and wherein a ratcheting mechanism is coupled to the second handle, the ratcheting mechanism comprises a pawl configured to selectively engage the plurality of teeth of the blade.

16. A cutting tool comprising:
a body comprising:
a first end defining an opening;
a second end opposing the first end;
a cavity positioned in body and connected to the opening; and
a first handle extending between the opening and the second end;
a second handle pivotally coupled to the body, the second handle comprising:
a pivot end positioned within the cavity; and
an arm extending from the pivot end;
a locking mechanism comprising:
a shaft rotatably coupled to the body and positioned within the cavity; and
a lever coupled to the body and to the shaft;
a blade pivotally coupled to the body, the blade comprising:
an inner edge defining a cutting portion; and
an outer edge comprising a plurality of teeth; and
a pawl coupled to the second handle, the pawl configured to selectively engage the plurality of teeth of the blade.

17. The cutting tool of claim 16, wherein the lever is positioned on the body between the opening and the pawl.

18. The cutting tool of claim 16, wherein the lever is positioned on the body between the outer edge of the blade and the first end of the body.

19. The cutting tool of claim 16, wherein the blade is moved between a first position in which a gap is defined between the inner edge of the blade and the body, the gap is configured to receive a workpiece and a second position in which the blade abuts the body.

20. The cutting tool of claim 16, wherein the shaft further comprises a radially extending protrusion, and wherein the radially extending protrusion engages the arm of the second handle to resist movement of the second handle relative to the body.
